(19) United States
(12) Patent Application Publication
(10) Pub. No.: US 2018/0144304 A1
(43) Pub. Date: May 24, 2018

(54) CONTEXTUAL RECOMMENDATION OF MEMBER PROFILES

(71) Applicant: LinkedIn Corporation, Sunnyvale, CA (US)

(72) Inventor: Krishnaram Kenthapadi, Sunnyvale, CA (US)

(21) Appl. No.: 15/359,313

(22) Filed: Nov. 22, 2016

(51) Int. Cl. G06Q 10/10; H04L 29/08

(52) U.S. Cl. CPC G06Q 10/103; G06Q 50/01; H04L 67/306

(57) ABSTRACT

A member recommendation system provided with an on-line social network system detects that a user is engaged in an editing session with respect to an electronic presentation at a computer system associated with a company and determines a set of skills that is discussed in the presentation. The member recommendation system uses an inverted index of employees skills and the determined set of skills to select identifications of those employees that have been identified as associated with one or more of the skills in the inverted index of employees skills. References to at least some of the selected identifications of employees are recommended to the user of the presentation.

### TECHNICAL FIELD

This application relates to the technical fields of software and/or hardware technology and, in one example embodiment, to system and method to generate a set of member profiles that represent co-workers of a user engaged in an editing session with respect to an electronic presentation and that are associated with skills discussed in the electronic presentation.

### BACKGROUND

An electronic presentation (e.g., a slideshow produced using presentation software such as PowerPoint or a web-based slide-hosting service such as SlideShare) is a useful means for sharing information with colleagues, associates, and the public at large. The information being shared may include various concepts—scientific, technical, etc.—that are being referenced but not discussed in much detail due to the time constraints that limits the amount of information that can be reasonably imparted by a presentation. At times, a user who is in the process of authoring or editing a presentation may benefit from the existing knowledge of others during the editing or authoring session, especially if they could reach out to people who work within the same organization, i.e., to their co-workers. The user and/or the user's co-workers could be members of an on-line social network that represents its members by means of respective member profiles.

An on-line social network is a platform for connecting people in virtual space. An on-line social network may be a web-based platform, such as, e.g., a social networking web site, and may be accessed by a user via a web browser or via a mobile application provided on a mobile phone, a tablet, etc. An on-line social network may be a business-focused social network that is designed specifically for the business community, where registered members establish and document networks of people they know and trust professionally. Each registered member is represented by a member profile. A member profile is represented by one or more web pages, or a structured representation of the member's information in XML (Extensible Markup Language), JSON (JavaScript Object Notation) or similar format. A member's profile web page of a social networking web site may emphasize employment history and professional skills of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to identify relevant member profiles for an electronic presentation may be implemented;

FIG. 2 is block diagram of a system to identify relevant member profiles for an electronic presentation, in accordance with one example embodiment;

FIG. 3 is a flowchart illustrating a method to identify relevant member profiles for an electronic presentation, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to identify member profiles that are relevant with respect to skills discussed in an electronic presentation is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

As mentioned above, a user who is in the process of authoring or editing a presentation may benefit from the existing knowledge of others, especially co-workers, during the editing or authoring of an electronic presentation. It may be beneficial to automatically determine which skills are being referenced in the presentation that is being edited from a computer system associated with a particular company, determine one or more company employees who are familiar with the skills discussed in the presentation, and display references to such employees to the editor/author of the presentation, as a recommendation. References to the recommended employees that may have expertize with one or more skills mentioned in the presentation may be presented as associated with a particular section of the presentation and/or at the beginning or at the end of the presentation. A skill, for the purposes of this description, is an item of information that represents a skill of a member in an on-line social network system and that is stored in a skills database maintained by the on-line social network system. Each skill-related entry in the skills database includes a phrase (e.g., “programming” or “patent prosecution”) that can appear in a member profile maintained by the on-line social network system in one or more designated profile sections, such as, e.g., in the skills and endorsements section of a profile.

For the purposes of this description the phrases “an on-line social networking application” and “an on-line social network system” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Members that are connected in this way to a particular member may be referred to as that particular member's connections or as that particular member's network. The profile information of a social network member may include various information such as, e.g., the name of a member, current and previous geographic location of a member, current and previous employment information of a member, information related to education of a member, information about professional accomplishments of a member, publications, patents, etc. As mentioned above, the profile information of a social network member may also include information about the member's professional skills.

In one embodiment, the system to identify relevant member profiles for an electronic presentation is implemented as a so-called member recommendation system that is provided as part of or associated with the on-line social network system. The member recommendation system detects that a user is engaged in an editing session with respect to an electronic presentation at a computer system associated with a company. For the purposes of this description, references to “electronic presentation” and “presentation” are to be understood to include any electronic document that can be edited or authored on a computer system. The term “company” is used to indicate any organization that has employees, or volunteers, or contractors, etc. The member recommendation system maintains or has access to an inverted index of employees skills associated with a company identification representing the company. An entry in the inverted index of employees skills comprises a skill mapped to an employee profile representing an employee of the company in the on-line social network system. The skill corresponds to an entry in a skills database maintained in the on-line social network system.

In response to detecting that the user is engaged in an editing session with respect to the electronic presentation, the member recommendation system determines which skills are being discussed in the presentation (a set of skills). The member recommendation system then uses the inverted index of employees skills to select member profiles of those employees that have been identified as associated with one or more of the skills discussed in the presentation. The selected member profiles are referred to as a set of employee profile identifications. The member recommendation system presents to the user references to at least sonic of those member profiles. For example, the member recommendation system may generate additional user interface including a presentation of references to member profiles of employees that have one or more skills discussed in the presentation with an invitation to contact those employees. An example additional user interface may include information about a recommended employee, such as, e.g., name, title, phone number and e-mail address, availability, etc.

In one embodiment, the member recommendation system generates, for each item in the set of employee profile identifications, a relevance value that reflects how familiar the employee is with a skill discussed in the presentation. The items in the set of employee profile identifications are then ranked based on the respective associated relevance values, and those employee identifications that have been assigned the highest relevance values are selected as being most relevant and therefore can be included in the so-called presentation set of employees. References to employees included in the presentation set of employees are recommended to the user of the presentation.

The set of employee profile identifications that have one or more skills discussed in the presentation section i may be referred to as a candidate set of employees and notated as V(i). It will be noted that the entire presentation can be treated as one section, in which case the presentation section i corresponds to the entire presentation.

A relevance value may be generated for an employee with respect to skills discussed in the entire presentation or with respect to skills discussed in a section of a presentation, e.g., for skills discussed in a particular slide in an electronic slideshow presentation. In some embodiments, the member recommendation system generates, for an employee, separate relevance values for separate sections of a presentation and then aggregates those separate relevance values to generate the final relevance value for the employee, which is to be treated as indicating relevance of the employee to skills discussed in the entire presentation.

Equation (1) below is an example of calculating the relevance value of an employee v with respect to all combined sections i in a presentation D.

$$relscore ( v ) = {\sum }_{i ∈ D} relscore ( v , i ) \times significance ( i ) \qquad Equation ( 1 )$$

where different sections i in a presentation D are assigned different significance values significance (i). A significance value for a section in a presentation may be assigned based on various predetermined criteria, such as, e.g., the positioning of a section within the document, the hierarchy of the presentation, etc. Some example methodologies for calculating relevance value for an employee with respect to a section in a presentation are described below.

In one embodiment, in order to generate relevance value for an employee with respect to a section in a presentation the member recommendation system first selects a set of most important skills discussed in a presentation section. The skills detected in a presentation section may be identified as most important skills based on their respective importance scores. The importance score for a skill c in a presentation section i may be notated as impscore (c, i) and may be determined using any of the approaches described further below. The member recommendation system maintains or has access to an inverted index of skill-to-employee mappings (also referred to as an inverted index of skills), where, for an employee v and a skill c, a mapping entry in the inverted index is in the form of:

skill (c)→List of (employee (v), significance score sigscore (c, v)),

where the significance score is a value assigned to an employee/skill pair to indicate the familiarity of the employee v with the skill c. The inverted index of skill-to-employee mappings can be ordered by decreasing significance scores.

The significance score for an employee/skill pair may be determined by constructing an employee skills graph for an employee, based on the member profile representing the employee in the on-line social network system, with nodes representing respective skills of the subject employee. The member recommendation system then applies a graph analysis algorithm, such as, e.g., PageRank, to generate the centrality score for each skill c that is present in the member profile representing the employee v. The centrality score for a skill c with respect to an employee v is notated as phi (c, v). The centrality score phi (c, v) can be used as the significance score. In some embodiments, the significance score sigscore (c, v) can be calculated using the centrality score phi (c, v) together with a so-called endorsement score, which is notated as endscore (c, v). The endorsement score for a skill c with respect to an employee v can be calculated based on the number of endorsements for the skill c and also based on data reflecting how authoritative the associated endorsers are. The authoritativeness of an endorser may be determined by constructing a connectedness graph for the employee, where the nodes represent the employee and the employee's connections in the on-line social network system, and using a graph analysis technique to determine the importance/authoritativeness of any given node. The significance score of an employee v in the candidate set of employees V(i) corresponding to the skills search query for the section i can be calculated using Equation (2) shown below.

sigscore (c, v)=f(phi(c,v), endscore (c, v)), Equation (2)

where f( . . . ) is a monotonically increasing function of two variables, such as, e.g., f(x,y)−xy, or f(x,y)−x·exp(y).

The significance scores calculated for employees with respect to skills are normalized across all employees from the set of employee profile identifications.

Returning to the discussion of generating the relevance value for an employee with respect to a section in a presentation, after having identified the skills that are being discussed in or that are associated with a presentation section, the member recommendation system forms a search query consisting of the most important skills in the presentation section i and queries the inverted index of skill-to-employee mappings. Based on the result of the query, the member recommendation system generates the candidate set V(i) of employees corresponding to the skills search query for the section i. The member recommendation system then performs aggregation of the skill-employee significance scores sigscore (c, v) and section-skill importance scores impscore (c, i) in order to rank the retrieved employees. The relevance value for an employee v in the candidate set V(i) of employees corresponding to the skills search query for the section i can be calculated using Equation (3) shown below.

relscore (v, i)=h({((impsco(c, i), sigscore (c, v))|c∈C(i)}), Equation (3)

where h is an aggregation function. For example, relscore (v, i) can be calculated as the sum of products of the importance score of a skill c with respect to the section i, impscore (c, i) and the significance score for an employee v with respect to skill c, sigscore (c, v), for all skills c in the set of skills C(i), using Equation (4) below.

$$relscore ( v , i ) = {\sum }_{c ∈ C} impscore ( c , i ) \times sigscore ( c , v ) \qquad Equation ( 4 )$$

In some embodiments, the significance score for an employee v with respect to skill c, sigscore (c, v), is binary; that is, it indicated that the employee either possesses a certain skill or not. In this scenario, the relevance value for an employee is generated based on the combined importance of all skills that are associated with the employee in the inverted index of skill-to-employee mappings.

In some embodiments, the importance score of a skill c with respect to the section i, impscore (c, i), is binary; that is, a skill is associated with (discussed or referenced in) the section i, or not. In this scenario, the relevance value for an employee v is generated based on the significance scores sigscore (c, v) associated with those skills that have been identified as most important for section i in the presentation and possessed the employee.

In some embodiments, the significance score for an employee v for imparting the skill c, sigscore (c, v), is not used. In this scenario, if the skills in the inverted index of skill-to-employee mappings are ordered by decreasing significance scores sigscore (c, v), the member recommendation system could use the ordering in the inverted index to rank the employees. In this case, the employees could be ranked by rank aggregation across the important skills, for example, using Burda Count method.

As mentioned above, the member recommendation system selects a so-called presentation set of employees based on the respective relevance values generated for the employees in the set of employee profile identifications. For example, the presentation set of employees may include a certain number employees that have the top ranks with respect to the section in the presentation. In another example, the presentation set of employees includes those employees from the candidate set that have relevance values greater or equal to a predetermined threshold. References from the set of employees presentation set of employees are exposed to the user at the time the user is viewing the associated section of the presentation.

In some embodiments, the member recommendation system may be configured to generate contextual employee recommendations: as the user transitions from one presentation section to another, the associated presentation set of employee recommendations is generated or accessed, where the employees to be recommended as relevant to the currently viewed section of the presentation are determined using one of the methodologies discussed above. The member recommendation system may also be configured to detect if the user interacted with the presented reference to a recommended employee e.g., if the user clicked on the employee recommendation) and to omit presentation of a reference to that employee in any of the subsequently presented sections.

As explained above, the member recommendation system, in the process of determining the relevance of an employee with respect to a presentation or with respect to a section of a presentation, may utilize the importance value of a skill c with respect to a presentation section i. This importance value notated above as impscore (c, i). Some example methodologies for generating the importance score of a skill with respect to a presentation section are described below.

In one embodiment, a so-called skills detector system may be used to determine which skills are referenced in an electronic presentation and to also generate respective importance scores of the determined skills as related to the presentation. The skills detector system is provided as part of or associated with the on-line social network system. The skills detector system is configured to determine which skills referenced in the presentation and may also be configured also determine respective importance scores of the determined skills as related to the presentation. In order to identify a phrase that appears in a presentation as representing a skill, the skills detector system determines whether the phrase is included in the skills database maintained by the on-line social network system. Respective importance scores of the determined skills may be generated as described below.

The skills detector system, according to some embodiments, is configured to construct a skills graph for a presentation, with nodes representing respective skills and edges being assigned a weight value that represent the degree of relatedness of the respective two skills represented by the two connecting nodes.

example, the two skills “patent prosecution” and “patent drafting” have a greater degree of relatedness than, e.g., the two skills “patent prosecution” and “landscape design.” The skills detector system may be configured to assign a value between “0” and “1” to an edge in a skills graph, e.g., with the greater value assigned to an edge indicating the greater degree of relatedness of the respective two skills represented by the two connecting nodes. Each section of a presentation is thus represented as part of a skills graph. A section in a presentation may correspond to a slide (as in a PowerPoint or a SlideShare presentation), or to a portion of a document included in a chapter or under a headings.

Where the skills detector system generates a skills graph for a presentation, it can calculate a so-called centrality score for each node of the skills graph (and thus for each detected skill). Respective centrality scores for the nodes in the skills graph may be determined by applying a graph analysis algorithm, such as, e.g., PageRank. The centrality score for a skill c in a presentation section i is notated as alpha (c, i).

The skills detector system also associates each skill detected in a presentation with a so-called document structure score, which can be determined by examining the structure in the presentation. For example, a skill represented by a phrase that occurs in the title of the presentation is assigned a larger document structure score than a skill identified by a phrase that occurs only in the body of the presentation. As another example, a skill represented by a phrase that is found under one of the top-level bullets is assigned a higher document structure score than a phrase representing a skill is found under one of the lower-level bullets. The document structure score for a skill c in a presentation section i is notated as beta (c, i).

Where the skills detector system generates a skills graph and, for each detected skill generated a respective document structure score, the importance score for a skill c in a presentation section i is calculated based on the associated centrality score alpha (c, i) and the associated document structure score beta (c, i), using Equation (5) below. Thus calculated importance score is notated as gamma (c, i).

gamma (c, i)=f(alpha (c, i), beta (c, i)). Equation (5)

where f( . . . ) is a monotonically increasing function of two variables, such as, e.g., f(x,y)=xy, or f(x,y)=x·exp(y).

In some embodiments, the skills detector system is configured to represent each section in a presentation as a feature vector in high-dimensional space. Some examples of dimensions, in addition to the skill dimension, are title, level in the document structure hierarchy, emphasis in the text presentation (e.g., whether the phrase representing a skill is highlighted, bold, italicized, etc.), occurrence of the skill in previous sections, and occurrence of the skill in subsequent sections. The skills detector system utilizes machine learning techniques to learn a statistical model for calculating the predicted importance score delta (c, i) for a skill c in a presentation section i. The learned model takes, as input, a matrix with skills detected in the presentation section i as rows and features related to the document section title, level, emphasis) as columns. The ground truth consists of sections together with the labeled set of important skills.

In some embodiments, the approaches described above for calculating the importance score for a skill c in a presentation section i as labda(c,i)=g (gamma (c, i), delta (c, i)), where g( . . . ) is a function of two variables, such as, e.g. a convex combination, g(x, y)=r x+(1−r)y, where r is a predetermined coefficient expressing respective weights to be assigned to x and y.

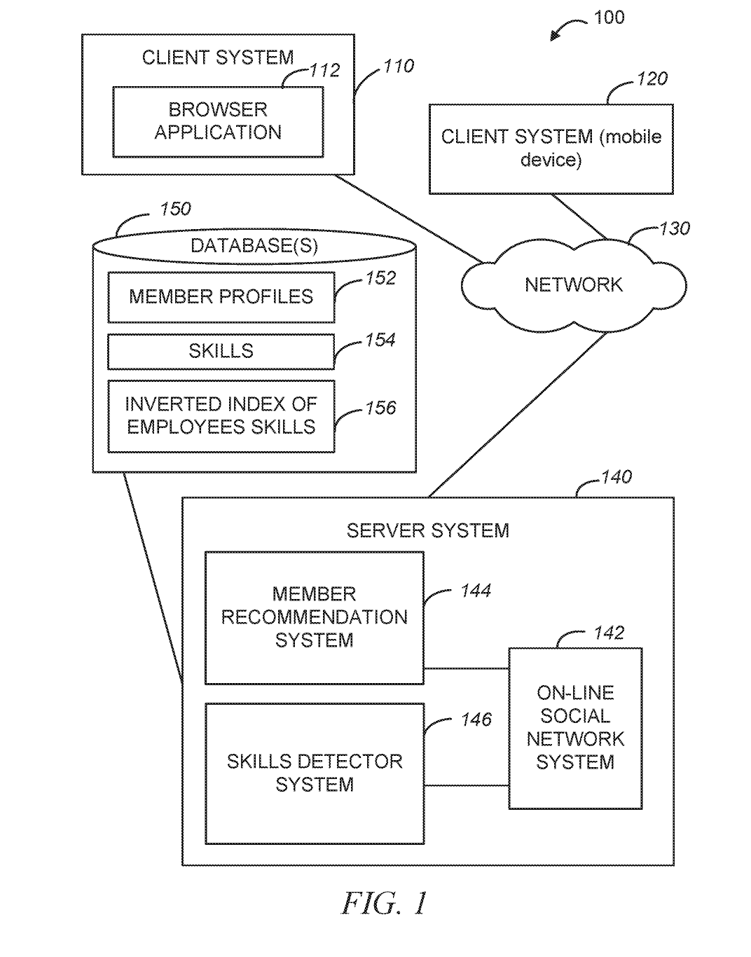

In some embodiments, the skills detector system is configured to select from the detected skills a set of most important skills in a section i, C(i) along with their corresponding importance scores calculated using one of the methodologies described above, and present it to the user. For example, the skills detector system may determine that a certain section in a subject presentation discusses two skills—“grant writing” and “proofreading”—and calculate respective importance scores for each of these skills. When that section of the subject presentation is being viewed by a user, the user can also be presented with the information regarding the skills being discussed in the section, their respective importance scores and an explanation of the importance scores (e.g., explaining that the importance scores were calculated based on the placement of the corresponding phrases within the document structure). Once the skills detector system determines the skills in each section of the presentation and their respective importance scores, this information may be stored as associated with the presentation and used, by the member recommendation system to recommend one or more educational programs or on-line employees that are relevant to one or more of these associated skills. An example member recommendation system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a member recommendation system 144 that is configured to have one or more functionalities described above. The member recommendation system 144 is configured to detect that a user is engaged in an editing session with respect to an electronic presentation at a computer system associated with a company and determines a set of skills that is discussed in the presentation. The member recommendation system 144 uses an inverted index of employees skills 156 stored in the database 150 and the determined set of skills to select identifications of those employees that have been identified as associated with one or more of the skills in the inverted index of employees skills 156. References to at least some of the selected identifications of employees are then recommended to the user of the presentation.

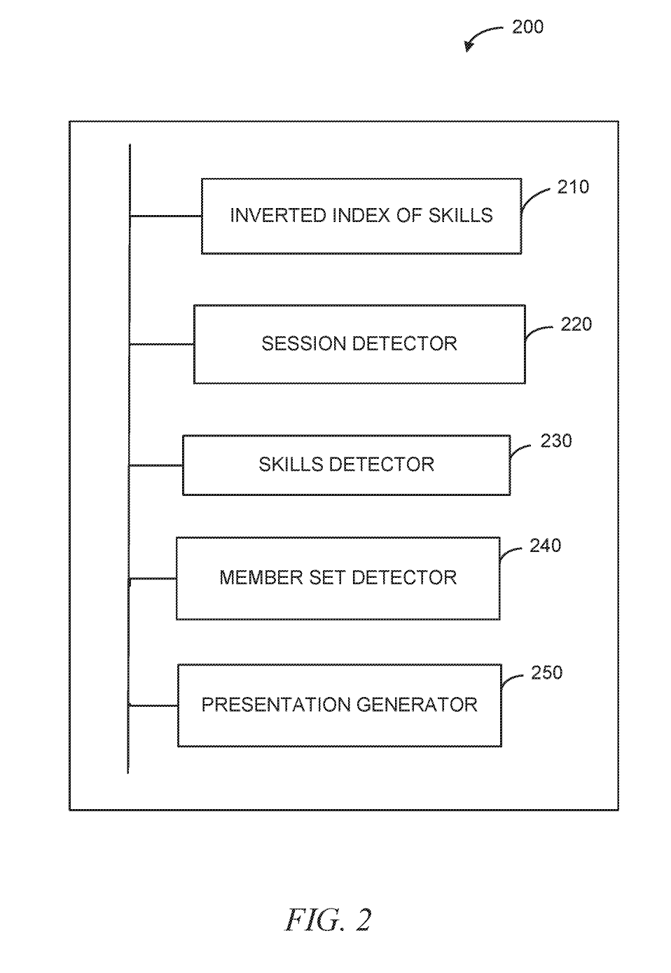

The server system 140 also hosts a skills detector system 146. The skills detector system 146 is configured to determine which skills are referenced in a presentation and generate respective importance scores of the determined skills as related to the presentation. As explained above, in order to identify a phrase that appears in a presentation as representing a skill, the skills detector system 146 determines whether the phrase is included in a skills database 154 maintained by the on-line social network system 142. The skills detector system 144 determines respective importance scores of the determined skills using any of the methodologies described above. An example member recommendation system 144 is illustrated in FIG. 2.

FIG. 2 is a block diagram of a system 200 to detect relevant employees for an electronic presentation. As shown in FIG. 2, the system 200 includes an inverted index of skills 210, a session detector 220, a skills detector 230, a member set detector 240, and a presentation generator 250. An inverted index of skills, which corresponds to the inverted index of employees skills 156 of FIG. 1 is associated with a company identification and is generated and maintained by or accessible by the on-line social network system 142 of FIG. 1. An entry in the inverted index of skills comprises a skill mapped to an employee profile representing an employee of a company represented by the company identification in the on-line social network system. The skill corresponds to an entry in the skills database 154 of FIG. 1.

The session detector 220 is configured to detect an editing session with respect to an electronic presentation, the editing session commenced at a computer system associated with the company identification. The skills detector 230 is configured to determine a set of skills associated with the electronic presentation, using one or more methodologies described above. The member set detector 240 is configured to generate, using the inverted index of employees skills, a set of employee profile identifications based on those entries from the inverted index of employees skills that include a skill from the set of skills associated with the electronic presentation.

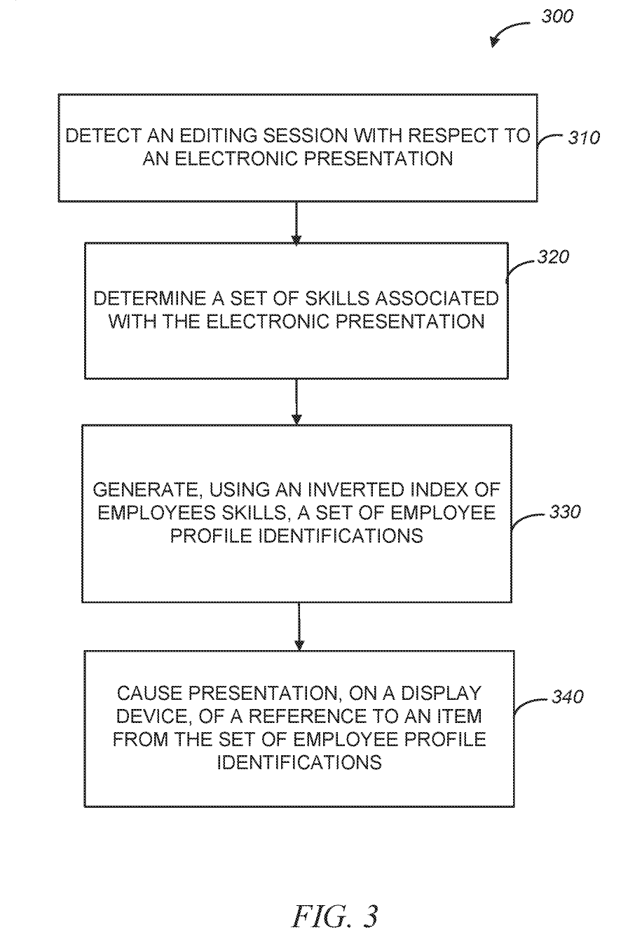

The presentation generator 250 is configured to cause presentation of a reference to an item from the set of employee profile identifications as associated with the electronic presentation. As mentioned above, references to the recommended employees may be presented at the beginning or at the end of the presentation, or as associated with a section on a presentation (e.g., as associated with a particular slide in an electronic slide presentation). In some embodiments, the presentation generator 250 is configured to generate additional user interface including an actionable control associated with to an item from the set of employee profile identifications to activate a preview of an associated employee profile in the on-line social network system. Some operations performed by the system 200 may be described with reference to FIG. 3.

FIG. 3 is a flowchart of a method 300 to detect relevant employees for an electronic presentation. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the session detector 220 of FIG. 2 detects an editing session with respect to an electronic presentation, the editing session commenced at a computer system associated with a company identification. The skills detector 230 of FIG. 2 determines a set of skills associated with the electronic presentation, at operation 320. At operation 330, member set detector 240 generates a set of employee profile identifications, using the inverted index of skills 210 of FIG. 2, based on those entries from the inverted index of skills 210 that include a skill from the set of skills associated with the electronic presentation. At operation 340, the presentation generator 250 of FIG. 2 causes presentation of a reference to an item from the set of employee profile identifications as associated with the electronic presentation.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

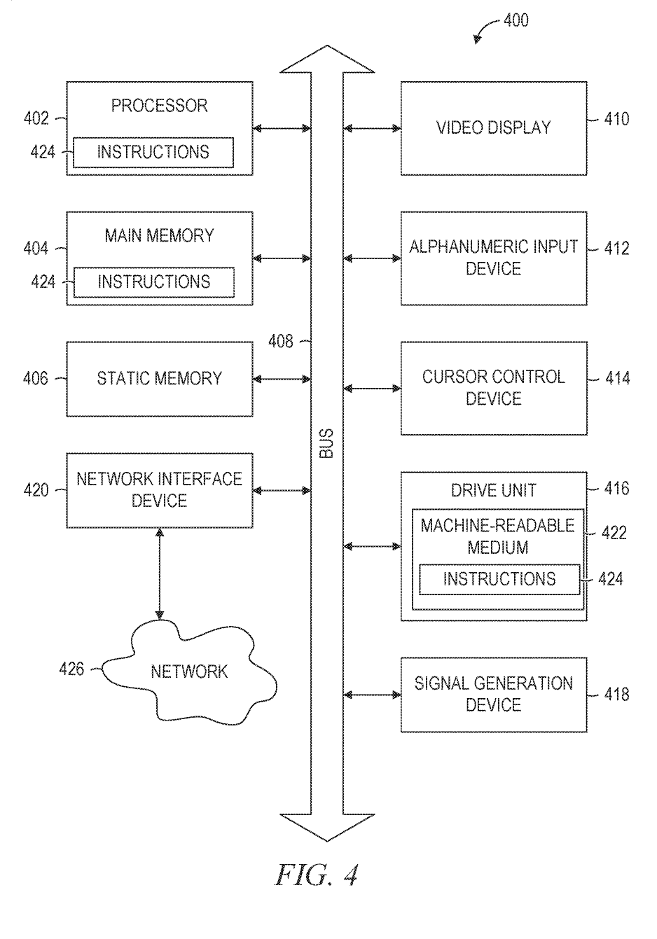

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to identify member profiles that are relevant with respect to skills discussed in an electronic presentation has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer implemented method comprising:
using at least one processor, maintaining an inverted index of employees skills associated with a company identification, an entry in the inverted index of employees skills comprising a skill mapped to an employee profile representing an employee of a company represented by the company identification in the on-line social network system, the skill corresponding to an entry in a skills database maintained in the on-line social network system;
detecting an editing session with respect to an electronic presentation, the editing session commenced at a computer system associated with the company identification;
determining a set of skills associated with the electronic presentation;
generating, using the inverted index of employees skills, a set of employee profile identifications based on those entries using the inverted index of employees skills that include a skill from the set of skills; and
causing presentation, on a display device, of a reference to an item from the set of employee profile identifications as associated with the electronic presentation.

2. The method of claim 1, comprising generating additional user interface, the additional user interface comprising an actionable control associated with the reference to activate a preview of an associated employee profile in the on-line social network system.

3. The method of claim 1, wherein the item is from a subset of the set of employee profile identifications, the subset of the set of employee profile identifications generated based on respective relevance values of items in a the set of employee profile identifications.

4. The method of claim 3, comprising generating a relevance value for an item in the set of employee profile identifications using a significance value associated with a pair comprising an employee identification from the item and the skill from the item.

5. The method of claim 4, wherein the generating of the relevance value comprises:
accessing a member profile associated with th employee identification in the on-line social network system;
generating a skills graph with nodes representing skills found in a skills section of the member profile, the skill from the item found in the skills section of the member profile; and
generating a centrality score for a node representing the skill from the item.

6. The method of claim 5, wherein the generating of the relevance value comprises using the centrality score as the significance value.

7. The method of claim 5, wherein the generating of the respective relevance values comprises using a value representing a number of endorsements associated with the skill from the item in addition to the centrality score to generate the significance value.

8. The method of claim 1, wherein the set of skills is associated with a section from a plurality of sections in the electronic presentation.

9. The method of claim 1, wherein the set of skills is associated with the entire electronic presentation.

10. The method of claim 1, wherein the electronic presentation is an electronic slide show.

11. A computer-implemented system comprising:
an inverted index of employees skills associated with a company identification, implemented using at least one processor, wherein an entry in the inverted index of employees skills comprising a skill mapped to an employee profile representing an employee of a company represented by the company identification in the on-line social network system, the skill corresponding to an entry in a skills database maintained in the on-line social network system;
a session detector, implemented using at least one processor, to detect an editing session with respect to an electronic presentation, the editing session commenced at a computer system associated with the company identification;
a skills detector, implemented using at least one processor, to determine a set of skills associated with the electronic presentation;
a member set detector, implemented using at least one processor, to generate, using the inverted index of employees skills, a set of employee profile identifications based on those entries using the inverted index of employees skills that include a skill from the set of skills; and
a presentation generator, implemented using at least one processor, to cause presentation, on a display device, of a reference to an item from the set of employee profile identifications as associated with the electronic presentation.

12. The system of claim 11, wherein the presentation generator is to generate additional user interface, the additional user interface comprising an actionable control associated with the reference to activate a preview of an associated employee profile in the on-line social network system.

13. The system of claim 11, wherein the item is from a subset of the set of employee profile identifications, the subset of the set of employee profile identifications generated based on respective relevance values of items in a the set of employee profile identifications.

14. The system of claim 13, wherein the member set detector is to generate a relevance value for an item in the set of employee profile identifications using a significance value associated with a pair comprising an employee identification from the item and the skill from the item.

15. The system of claim 14, wherein the member set detector is to:
access a member profile associated with the employee identification in the on-line social network system;
generate a skills graph with nodes representing skills found in a skills section of the member profile, the skill from the item found in the skills section of the member profile; and
generate a centrality score for a node representing the skill from the item.

16. The system of claim 15, wherein the member set detector is to use the centrality score as the significance value.

17. The system of claim 15, wherein member set detector is to use a value representing a number of endorsements associated with the skill from the item in addition to the centrality score to generate the significance value.

18. The system of claim 11, wherein the set of skills is associated with a section from a plurality of sections in the electronic presentation.

19. The system of claim 11, wherein the set of skills is associated with the entire electronic presentation.

20. A machine-readable non-transitory storage medium having instruction data executable by a machine to cause the machine to perform operations comprising:
maintaining an inverted index of employees skills associated with a company identification, an entry in the inverted index of employees skills comprising a skill mapped to an employee profile representing an employee of a company represented by the company identification in the on-line social network system, the skill corresponding to an entry in a skills database maintained in the on-line social network system;
detecting an editing session with respect to an electronic presentation, the editing session commenced at a computer system associated with the company identification;
determining a set of skills associated with the electronic presentation;
generating, using the inverted index of employees skills, a set of employee profile identifications based on those entries using the inverted index of employees skills that include a skill from the set of skills; and
causing presentation, on a display device, of a reference to an item from the set of employee profile identifications as associated with the electronic presentation.
